(19) United States
(12) Patent Application Publication
(10) Pub. No.: US 2025/0304047 A1
(43) Pub. Date: Oct. 2, 2025

(54) CONTROL DEVICE, CONTROL METHOD, AND STORAGE MEDIUM

(71) Applicant: HONDA MOTOR CO., LTD., Tokyo (JP)

(72) Inventors: Hironori HIRATA, Tokyo (JP); Yoshihiro KATSUYAMA, Tokyo (JP)

(73) Assignee: HONDA MOTOR CO., LTD., Tokyo (JP)

(21) Appl. No.: 19/064,713

(22) Filed: Feb. 27, 2025

(30) Foreign Application Priority Data
Mar. 27, 2024 (JP) 2024-050836

(51) Int. Cl. B60W 30/09; B60W 30/095; B60W 30/182; B60W 60/00; G06V 20/58

(52) U.S. Cl. CPC B60W 30/09; B60W 30/0956; B60W 30/182; B60W 60/0015; G06V 20/58; B60W 2420/403; B60W 2420/408; B60W 2554/402; B60W 2556/10

(57) ABSTRACT

A control device for a moving object, the control device includes: an external environment recognition unit configured to acquire external environment recognition data of the moving object; a storage unit configured to store a route history of the route used when the moving object moves to a target position; and a movement control unit configured to perform movement control of moving the moving object to the target position along a section to the target position. The movement control unit switches a usage mode of the route history in the movement control in a first section included in the section in which it is difficult to move without referring to the route history and a second section that is included in the section and that is different from the first section, and generates a travel route.

This application is based upon and claims the benefit of priority from prior Japanese patent application No. 2024-50836, filed on Mar. 27, 2024, the entire contents of which are incorporated herein by reference.

### TECHNICAL FIELD

The present disclosure relates to a control device, a control method, and a storage medium storing a control program.

### BACKGROUND ART

In recent years, active efforts have been made to provide access to a sustainable transportation system in consideration of vulnerable people among traffic participants. In order to implement the above, focus has been placed on research and development on further improving safety and convenience of traffic by research and development related to autonomous driving techniques.

In the related art, in an autonomous driving system that causes a vehicle to travel autonomously without requiring a driving operation of a user, it is known that a route taken when a vehicle travels to a target position by a driving operation of a user is stored, and when the vehicle travels toward the same target position or on the same route, the vehicle is caused to travel based on a stored route history. In addition, it is known that route information on a route from a current position to the target position is generated based on information acquired by an in-vehicle sensor to cause the vehicle to travel.

For example, JP2023-63070A discloses a vehicle travel assist device that, in a case

where it is determined that a vehicle will enter an intrusion prohibited area when moving along a target route, provides assist in correcting the target route in a stored route history so that the vehicle does not enter the intrusion prohibited area, and provides assist in moving the vehicle to a target stop position along the corrected target route and stopping the vehicle at the target stop position.

### SUMMARY OF INVENTION

As described above, JP2023-63070A discloses that, when the vehicle moves to the target position, a travel route to the target position is generated based on the route history stored in a storage unit according to a situation during the movement. However, if there is a travel area for which a travel route is preferably generated based on a route history when causing a vehicle to travel to a target position, there is also a travel area for which a travel route is preferably generated without being based on a route history. Patent JP2023-63070A does not disclose generation of a route according to a travel area. Therefore, there is room for improvement in the way of generating the travel route to the target position.

Aspects of the present disclosure relate to providing a control device, a control method, and a storage medium storing a control program capable of generating a more appropriate movement route.

According to an aspect of the present disclosure, there is provided a control device for a moving object, the control device including:
an external environment recognition unit configured to acquire external environment recognition data of the moving object;
a storage unit configured to store a route history of the route used when the moving object moves to a target position; and
a movement control unit configured to perform movement control of moving the moving object to the target position along a section to the target position, in which
the movement control unit switches a usage mode of the route history in the movement control in a first section included in the section in which it is difficult to move without referring to the route history and a second section that is included in the section and that is different from the first section, and generates a travel route.

According to another aspect of the present disclosure, there is provided a control method for a moving object, the moving object including an external environment recognition unit configured to acquire external environment recognition data of the moving object, a storage unit configured to store a route history of a route used when the moving object moves to a target position, and a movement control unit configured to perform movement control of moving the moving object to the target position along a section to the target position, the control method including:
switching, by the movement control unit, a usage mode of the route history in the movement control in a first section included in the section in which it is difficult to move without referring to the route history and a second section that is included in the section and that is different from the first section, and generates a travel route.

According to another aspect of the present disclosure, there is provided a non- transitory computer-readable storage medium storing a control program for a moving object, the moving object including an external environment recognition unit configured to acquire external environment recognition data of the moving object, a storage unit configured to store a route history of a route used when the moving object moves to a target position, and a movement control unit configured to perform movement control of moving the moving object to the target position along a section to the target position, the control program causing the movement control unit to execute a process, the process including:
switching a usage mode of the route history in the movement control in a first section included in the section in which it is difficult to move without referring to the route history and a second section that is included in the section and that is different from the first section, and generates a travel route.

According to aspects of the present disclosure, it is possible to provide a control device, a control method, and a control program capable of generating a more appropriate movement route, thereby contributing to development of a sustainable transportation system.

### BRIEF DESCRIPTION OF DRAWINGS

Exemplary embodiment(s) of the present invention will be described in detail based on the following figures, wherein:

FIG. 1 is a block diagram illustrating a configuration of a vehicle 1 equipped with a control device 100 of an embodiment;

FIG. 2 is a diagram illustrating an example of a first section and a second section to a target position to which the vehicle 1 moves;

FIG. 3 is a diagram illustrating an example of a switching timing of a second section and a first section where the vehicle 1 moves;

FIG. 4 is a flowchart illustrating an example of switching between traveling based on a route history and traveling based on external environment recognition data;

FIG. 5 is a flowchart illustrating a modification of switching between the traveling based on a route history and the traveling based on external environment recognition data;

FIG. 6 is a flowchart illustrating an example of control during autonomous traveling based on a route history by an ADAS_ECU 131; and

FIG. 7 is a flowchart illustrating a modification of control during autonomous traveling based on a route history by the ADAS_ECU 131.

### DESCRIPTION OF EMBODIMENTS

Hereinafter, an embodiment of a control device, a control method, and a storage medium storing a control program according to the present disclosure will be described with reference to the accompanying drawings.

### Vehicle 1 Equipped with Control Device 100 According to Embodiment

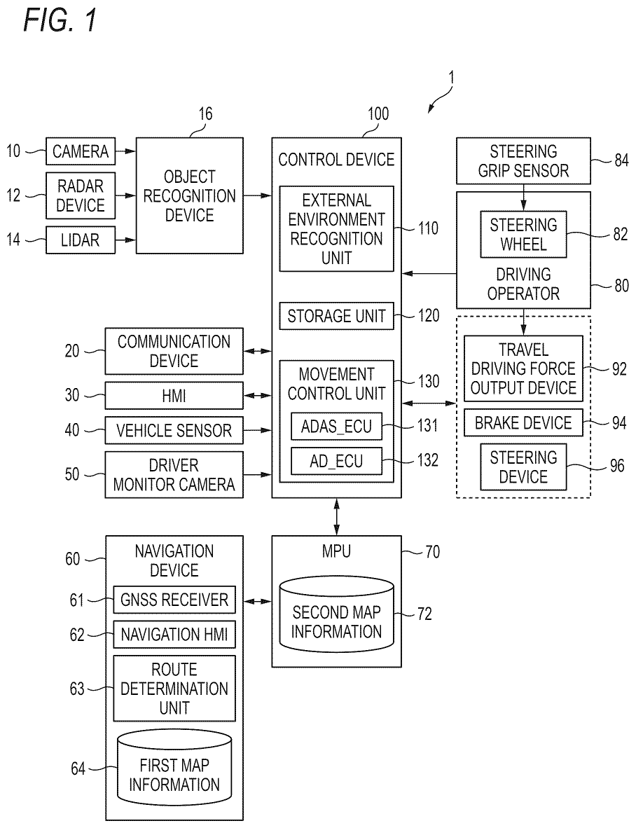

FIG. 1 is a block diagram illustrating a configuration of a vehicle 1 equipped with a control device 100 according to an embodiment. The vehicle 1 is an example of a “moving object” in the present disclosure. The vehicle 1 is a vehicle that can execute so-called autonomous driving or assisted driving. The vehicle 1 is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by an electric generator connected to the internal combustion engine or electric power discharged from a secondary battery or a fuel cell.

The vehicle system 1 includes, for example, a camera 10, a radar device 12, light detection and ranging (LIDAR) 14, an object recognition device 16, a communication device 20, a human machine interface (HMI) 30, a vehicle sensor 40, a driver monitor camera 50, a navigation device 60, a map positioning unit (MPU) 70, a driving operator 80, the control device 100, a travel driving force output device 92, a brake device 94, and a steering device 96. These devices and equipment are connected to each other via, for example, a multiplex communication line such as a controller area network (CAN) communication line, a serial communication line, or a wireless communication network.

The camera 10 is, for example, a digital camera using a solid-state imaging device such as a charge coupled device (CCD) or a complementary metal oxide semiconductor (CMOS). The camera 10 is attached at any postilion on the vehicle 1.

The radar device 12 emits radio waves such as millimeter waves around the vehicle 1, and detects radio waves (reflected waves) reflected by an object to detect at least a position (distance and orientation) of the object. The radar device 12 is attached at any position on the vehicle 1.

The LIDAR 14 emits light (or an electromagnetic wave having a wavelength close to that of light) around the vehicle 1 and measures scattered light. The LIDAR 14 detects a distance to a target based on a time elapsed from light emission to light reception. The emitted light is, for example, pulsed laser light. The LIDAR 14 is attached at any postilion on the vehicle 1.

The object recognition device 16 performs sensor fusion processing on some or all of detection results of the camera 10, the radar device 12, and the LIDAR 14 to recognize a position, a type, a speed, and the like of an object. The object recognition device 16 outputs a recognition result to the control device 100. The object recognition device 16 may output the detection results of the camera 10, the radar device 12, and the LIDAR 14 to the control device 100 as they are.

The communication device 20 uses, for example, a cellular network, a Wi-Fi (registered trademark) network, Bluetooth (registered trademark), or dedicated short range communication (DSRC) to communicate with other vehicles present around the vehicle 1 or communicate with various server devices via a radio base station.

The HMI 30 presents various types of information to an occupant of the vehicle 1 and receives an input operation from the occupant. The HMI 30 includes various types of display devices, a speaker, a buzzer, a touch panel, a switch, keys, and the like.

The vehicle sensor 40 includes a vehicle speed sensor that detects a speed of the

15 vehicle 1, an acceleration sensor that detects an acceleration, a yaw rate sensor that detects an angular velocity around a vertical axis, an azimuth sensor that detects an orientation of the vehicle 1, and the like.

The driver monitor camera 50 is, for example, a digital camera using a solid-state imaging device such as a CCD or a CMOS. The driver monitor camera 50 is attached at any position on the vehicle 1 in a position and an orientation in which the head of the occupant (hereinafter, also referred to as a “driver”) seated in a driver's seat of the vehicle 1 is able to be imaged from the front (that is, in an orientation in which the face is imaged).

The navigation device 60 includes, for example, a global navigation satellite system (GNSS) receiver 61, a navigation HMI 62, and a route determination unit 63. The navigation device 60 stores first map information 64 in a storage device such as a hard disk drive (HDD) or a flash memory.

The GNSS receiver 61 specifies a position of the vehicle 1 based on a signal received from a GNSS satellite. The position of the vehicle 1 may be specified or complemented by an inertial navigation system (INS) using an output of the vehicle sensor 40.

The navigation HMI 62 includes a display device, a speaker, a touch panel, a key, and the like. The navigation HMI 62 may be partially or entirely unified with the HMI 30 described above.

For example, with reference to the first map information 64, the route determination unit 63 determines a route (hereinafter, also referred to as an “on-map route”) from the position of the vehicle 1 specified by the GNSS receiver 61 (or any position that is received) to a destination input by the occupant using the navigation HMI 62. The first map information 64 is, for example, information in which a road shape is expressed by a link indicating a road and nodes connected by the link. The first map information 64 may include a curvature of a road, point of interest (POI) information, and the like. The on-map route is output to the MPU 70.

The navigation device 60 may perform route guidance using the navigation HMI 62 based on the on-map route. The navigation device 60 may transmit a current position and the destination to a navigation server via the communication device 20 and acquire a route equivalent to the on-map route from the navigation server.

The MPU 70 holds second map information 72 in a storage device such as an HDD or a flash memory. The second map information 72 is map information with higher accuracy than the first map information 64. The second map information 72 includes, for example, information on a center of a lane or information on a boundary of the lane. The second map information 72 may include road information, traffic regulation information, address information, facility information, telephone number information, and the like. The second map information 72 may be updated, as required, by the communication device 20 communicating with another device.

The driving operator 80 includes, for example, an accelerator pedal, a brake pedal, a shift lever, and other operators in addition to a steering wheel 82 (an example of a steering device). A sensor that detects an operation amount or presence or absence of an operation is attached to the driving operator 80, and a detection result thereof is output to some or all of the control device 100, the travel driving force output device 92, the brake device 94, and the steering device 96. The steering wheel 82 is not necessarily in an annular shape, and may be in the form of irregular steering, joy stick, button, or the like.

A steering grip sensor 84 is attached to the steering wheel 82. The steering grip sensor 84 is implemented by a capacitance sensor or the like, and outputs, to the control device 100, a signal capable of detecting whether the driver is gripping the steering wheel 82.

The control device 100 includes an external environment recognition unit 110, a storage unit 120, and a movement control unit 130.

The external environment recognition unit 110 acquires, from the object recognition device 16, external environment recognition data for recognizing an external environment of the vehicle 1 that is acquired by the camera 10, the radar device 12, and the LIDAR 14.

The storage unit 120 stores a program for the movement control unit 130 to control each unit. For example, the storage unit 120 stores a route history generated when the vehicle 1 moves to a target position. The “route history” is a route history generated when the vehicle 1 moves to the target position by the driving of a user. The target position is, for example, a garage when the vehicle 1 is to enter a garage, and is a predetermined position (exit position) outside the garage when the vehicle 1 is to exit from the garage.

The movement control unit 130 includes an advanced driver assistance system electronic control unit (ADAS_ECU) 131 and an automatic driving electronic control unit (AD_ECU) 132. The ADAS_ECU 131 is an example of a “first control unit” in the present disclosure. The AD_ECU 132 is an example of a “second control unit” in the present disclosure.

Each of the ADAS ECU 131 and the AD_ECU 132 is implemented by, for example, a hardware processor such as a central processing unit (CPU) executing a program (software). Some or all of these components may be implemented by hardware (including circuitry) such as a large scale integration (LSI), an application specific integrated circuit (ASIC), a field-programmable gate array (FPGA), and a graphics processing unit (GPU), or may be implemented by cooperation of software and hardware. The program may be stored in advance in a storage device such as an HDD or a flash memory of the control device 100.

The movement control unit 130 performs movement control of moving the vehicle 1 to a target position. The movement control unit 130 switches a usage mode of a route history in movement control in a first section of a section to the target position in which it is difficult to move without referring to the route history and a second section different from the first section of the section to the target position, and generates a travel route. That is, the movement control unit 130 switches the usage mode of the route history in generating a travel route in the movement control in the first section and the second section. “Referring to a route history” refers to, for example, moving the vehicle 1 to a target position under control by tracing a route history. “It being difficult to move without referring to a route history” refers to a case where, for example, if the vehicle 1 is to be moved to a target position based on only external environment recognition data without referring to a route history, turning of the steering increases in consideration of a turning radius of the vehicle. Specifically, it refers to a case of movement in which, in moving the vehicle 1 to a target position, it is difficult to move when not going in a right travel route and if the vehicle 1 is moved based on external environment recognition data, the vehicle 1 moves in a route different from the right travel route and the number of times of turning is increased.

Examples of the “first section” include, for example, a part of a private land. Examples of the “second section” include, for example, a section other than the “first section” in the private land, and a general road. The “usage mode of a route history” includes, for example, a mode of tracing or not tracing a route history and a mode in which control based on a route history is mainly used or control based on external environment recognition data is mainly used. The mode in which the control based on a route history is mainly used may include, for example, a mode in which the external environment recognition data is used supplementarily. The mode in which the control based on external environment recognition data is mainly used may include, for example, a mode in which the route history is used supplementarily.

In the first section, the movement control unit 130 performs movement control of moving the vehicle 1 to the target position by referring to the route history, and in the second section, the movement control unit 130 performs movement control of moving the vehicle 1 to the target position based on the external environment recognition data without referring to the route history. The “referring to the route history” may not only include using the route history but also include supplementarily using the external environment recognition data. Specifically, in a case where an obstacle that is not detected in the route history is detected from the external environment recognition data while the vehicle 1 is being moved to the target position using the route history, stopping the vehicle 1 due to prediction of a collision, traveling by avoiding the obstacle, and the like are included.

The first section is, for example, a section in which smooth traveling cannot be achieved with only the external environment recognition data since obstacles and the like are intricately present in the travel route of the vehicle 1, that is, a section in which the vehicle 1 travels mainly based on the route history. The second section is a section in which smooth traveling can be achieved with only the external environment recognition data, that is, a section in which the vehicle 1 travels mainly based on the external environment recognition data without referring to the route history and can flexibly cope with an environmental change during the traveling. The environmental change is, for example, the appearance of an obstacle that was not there before and the disappearance of an obstacle that was there before.

The ADAS_ECU 131 performs movement control of the vehicle 1 based on the route history in the first section of the section to the target position in which it is difficult to move without referring to the route history. The ADAS_ECU 131 controls, for example, garage entry and exit of the vehicle 1.

The AD_ECU 132 performs movement control of the vehicle 1 based on the external environment recognition data in the second section different from the first section of the section to the target position. For example, the AD_ECU 132 controls travelling of the vehicle 1 that is different from the garage entry and exit of the vehicle 1. The “traveling of the vehicle 1 that is different from the garage entry and exit”, is, for example, traveling on a general road and traveling along a road or a lane.

Further, when an obstacle is detected based on the external environment recognition data even during the execution of the movement control based on the route history in the first section, the movement control unit 130 switches the movement control of the vehicle 1 performed by the ADAS_ECU 131 to the movement control of the vehicle 1 performed by the AD_ECU 132. The “obstacle” is an object that obstructs the movement of the vehicle 1 according to the movement control, and includes, for example, an installed object, another vehicle, and a person.

Further, the movement control unit 130 acquires the external environment recognition data by causing the vehicle 1 to travel under the control of the AD_ECU 132, and sets the first section and the second section based on the external environment recognition data. For example, the movement control unit 130 sets, as the first section, a section, in which a shape of a road is complicated (many obstacles are around), of a route generated by the AD_ECU 132 based on the external environment recognition data. The set first section is stored in the storage unit 120. When turning is included in the route generated by the AD_ECU 132 based on the external environment recognition data, the movement control unit 130 sets, as the first section, sections before and past the point. However, when the number of times of turning included in the route history generated when the user actually drives in the section is larger than the number of times of turning included in the route generated by the AD_ECU 132 based on the external environment recognition data, the sections before and past the point may not be set as the first section.

In addition, the movement control unit 130 sets the first section and the second section based on a travel history generated when the user drives the vehicle 1. For example, during traveling of the vehicle 1 according to driving of the user, the movement control unit 130 also performs route generation based on the external environment recognition data by the AD_ECU 132, and sets, as the first section, a section where a route actually traveled by the user deviates greatly from a route generated by the AD_ECU 132. Further, the movement control unit 130 sets, as the first section, a section in which a travel speed is lower than a predetermined speed during traveling of the vehicle 1 according to the driving of the user. The movement control unit 130 stores the set first section and second section in the storage unit 120 to be used in subsequent movement control.

When an obstacle is detected during the execution of the movement control of the vehicle 1 in the first section, the movement control unit 130 performs movement control based on at least one of a type and a movement state of the detected obstacle. For example, in a case where the obstacle is a moving object (a pedestrian, a moving vehicle, or the like), the vehicle 1 is moved under control by generating a travel route having a passing margin with a larger distance from the obstacle as compared with a case where the obstacle is a stationary object (a permanently installed dustbin). In the case where the obstacle is a moving object (a pedestrian, a moving vehicle, or the like), when the obstacle is approaching the travel route of the vehicle 1 (the host vehicle), the vehicle 1 is stopped.

The travel driving force output device 92 outputs, to driving wheels, a travel driving force (torque) for the vehicle to travel. The travel driving force output device 92 includes, for example, a combination of an internal combustion engine, an electric motor, a transmission, and the like, and an electronic control unit (ECU) that controls the combination. The ECU controls the above configuration according to information received from the movement control unit 130 or information received from the driving operator 80.

The brake device 94 includes, for example, a brake caliper, a cylinder that transmits a hydraulic pressure to the brake caliper, an electric motor that generates the hydraulic pressure in the cylinder, and a brake ECU. The brake ECU controls the electric motor according to the information received from the movement control unit 130 or the information received from the driving operator 80, and outputs a braking torque to each wheel according to a braking operation.

The steering device 96 includes, for example, a steering ECU and an electric motor. The electric motor changes an orientation of a steered wheel, for example, by applying a force to a rack-and-pinion mechanism. The steering ECU drives the electric motor according to the information received from the movement control unit 130 or the information received from the driving operator 80 to change the orientation of the steered wheel.

### Examples of First Section and Second Section

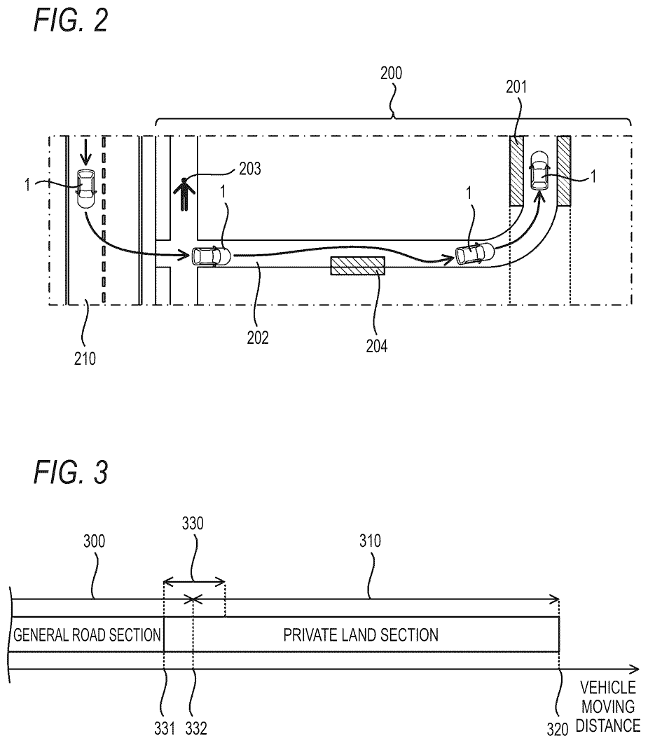

FIG. 2 is a diagram illustrating an example of a first section and a second section to a target position to which the vehicle 1 moves. As illustrated in FIG. 2, in this example, the target position to which the vehicle 1 moves is a garage 201 provided in a private land 200. The first section of a section to the target position (garage 201) to which the vehicle 1 moves is a drive way 202 provided in the private land 200. The second section of the section to the target position to which the vehicle 1 moves is a general road 210 that is a section other than the private land 200.

As indicated by an arrow, the vehicle 1 enters the private land 200 from a state in which the vehicle 1 is traveling on the general road 210, and is to enter the garage 201 provided in the private land 200. During traveling on the general road 210 (second section), the vehicle 1 travels along a road or a lane under the control of the AD_ECU 132 based on external environment recognition data acquired by the camera 10 or the like. Under the control of the AD_ECU 132, the vehicle 1 turns left from the general road 210 based on the external environment recognition data and travels to the drive way 202 of the private land 200. When the vehicle 1 enters the private land 200 and travels in the drive way 202 (first section), the vehicle 1 travels toward the garage 201 under the control of the ADAS_ECU 131 based on a route history stored in the storage unit 120. An obstacle 204 in the middle of the drive way 202 is, for example, a permanently installed dustbin. The route history is a route history generated when the vehicle 1 travels in the drive way 202 and enters the garage 201 by manual driving of the user.

However, the vehicle 1 may travel under the control of the AD_ECU 132 by taking, as the second section, a section of the drive way 202 where there is no obstacle, for example, a leading section of the drive way 202 from a point of left turning on the general road 210 to a point where the obstacle 204 is located. Further, for example, in a case where a pedestrian 203 approaching the drive way 202 is detected at a time-point when the vehicle 1 turns left on the general road 210 and enters the drive way 202, the vehicle 1 may travel under the control of the AD_ECU 132 based on the external environment recognition data without being based on the route history.

### Switching for Second Section and First Section

FIG. 3 is a diagram illustrating an example of a switching timing for the second section and the first section where the vehicle 1 moves. As illustrated in FIG. 3, when the vehicle 1 enters a private land section 310 serving as an example of the first section from a general road section 300 serving as an example of the second section, and travels to a target position (for example, a position of a garage at which the vehicle 1 is to be parked) 320 within a private land, a switching section 330 for switching the movement control of the vehicle 1 is set in a boundary area between the general road section 300 and the private land section 310. The switching section 330 is set, for example, starting from a boundary position 331 that is a boundary between a general road and a private land.

In a case where a travel section of the vehicle 1 changes from the second section to the first section, the control device 100 performs route generation by the ADAS_ECU 131 based on the route history and route generation by the AD_ECU 132 based on the external environment recognition data at least in the switching section 330. When the vehicle 1 travels from the general road section 300 to the private land section 310, the control device 100 prepares for the movement control to be performed by the ADAS_ECU 131 based on the route history while performing the movement control by the AD_ECU 132 based on the external environment recognition data that is executed during the traveling in the general road section 300, and switches to the movement control performed by the ADAS_ECU 131 at a timing of reaching a switching position 332 where the preparation is completed and the transfer is possible.

In this example, a case where the travel section of the vehicle 1 is changed from the second section to the first section is described, and the disclosure is not limited thereto. For example, it also applies to a case where the travel section of the vehicle 1 is changed from the first section to the second section. That is, the control device 100 prepares for the movement control to be performed by the AD_ECU 132 based on the external environment recognition data while performing the movement control by the ADAS_ECU 131 based on the route history that is executed during the traveling in the private land section 310, and switches to the movement control performed by the AD_ECU 132 at a timing of reaching a switching position where the preparation is completed and the transfer is possible.

### Control Example of Control Device 100

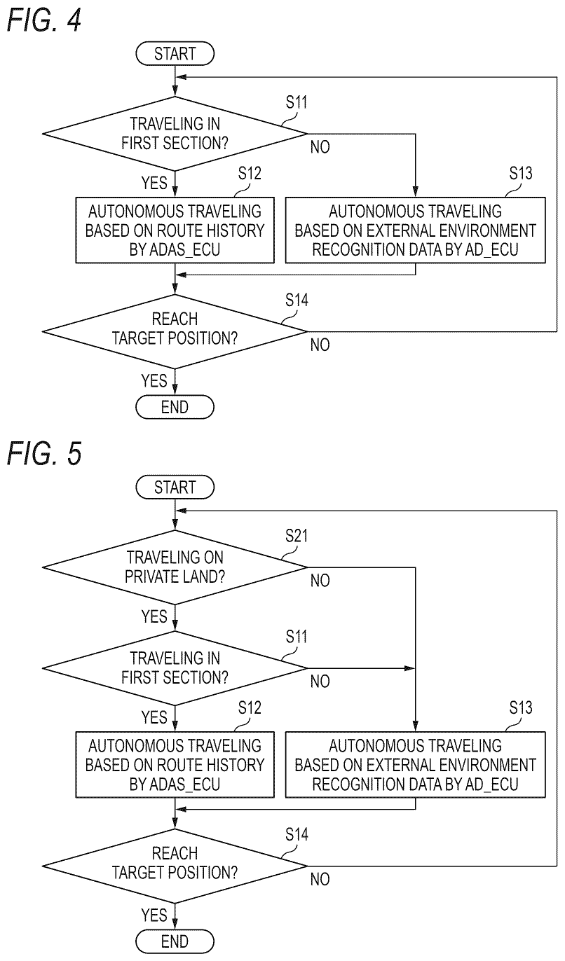

Next, movement control of moving the vehicle 1 to a target position performed by the control device 100 will be described with reference to FIGS. 4 to 7. FIG. 4 is a flowchart illustrating an example of switching between traveling based on a route history and traveling based on external environment recognition data. It is assumed that the vehicle 1 is executing autonomous driving, and is traveling with the garage 201 in the private land 200 as illustrated in FIG. 2 as a final target position, for example.

The control device 100 determines whether the vehicle 1 is currently traveling in a first section (step S11). The first section is a section of the section to the target position as described above in which it is difficult to move without referring to a route history, and is a section stored in the storage unit 120 as a route history.

If the vehicle is traveling in the first section in step S11 (step S11: Yes), the control device 100 performs autonomous traveling based on the route history by the ADAS_ECU 131 (step S12). On the other hand, if it is determined in step S11 that the vehicle is not traveling in the first section (step S11: No), the control device 100 determines that the vehicle is traveling in a second section different from the first section, and performs autonomous traveling based on the external environment recognition data by the AD_ECU 132 (step S13). The second section is a section in which the vehicle can move based on the external environment recognition data without referring to the route history.

Next, the control device 100 determines whether the vehicle 1 reaches the target position (garage 201) (step S14).

In step S14, if the vehicle does not reach the target position (step S14: No), the control device 100 returns to step S11 and repeats each processing. On the other hand, if the vehicle reaches the target position (step S14: Yes), the control device 100 ends the present process.

When switching the control performed by the ADAS_ECU 131 based on the route history and the control performed by the AD_ECU 132 based on the external environment recognition data, as described above with reference to FIG. 3, the other control is prepared while the control being executed is maintained, and the switching is performed at a timing when the preparation is completed and the transfer is possible.

As described above, according to the control device 100 of this example, movement control of the vehicle 1 based on a route history by the ADAS_ECU 131 is performed in a first section of a section to the target position in which it is difficult to move without referring to the route history, and movement control of the vehicle 1 based on external environment recognition data by the AD_ECU 132 is performed in a second section different from the first section. Therefore, the movement control can be switched according to a road condition under which the vehicle 1 travels, and an appropriate travel route can be generated.

FIG. 5 is a flowchart illustrating a modification of switching between the traveling based on a route history and the traveling based on external environment recognition data. It is assumed that the vehicle 1 is executing the autonomous driving as in the case in FIG. 4, and the vehicle 1 is traveling toward a target position (the garage 201 in the private land 200).

In this modification, first, the control device 100 determines whether the vehicle 1 is currently traveling on the private land 200 (step S21). The determination as to whether the land is the private board 200 can be made based on the first map information 64, the second map information 72, and current position information of the vehicle 1.

In step S21, if the vehicle is not traveling on the private land 200 (step S21: No), the control device 100 determines that the vehicle is traveling on a general road, and performs autonomous traveling based on the external environment recognition data by the AD_ECU 132 (step S13). In the process of this modification, it is assumed that the first section is a section present in a private land, and when the vehicle is traveling on a general road, it is determined that the vehicle is traveling in a second section different from the first section.

On the other hand, in step S21, if the vehicle 1 is traveling on the private land 200 (step S21: Yes), the control device 100 determines whether the vehicle 1 is traveling in the first section (step S11).

In step S11, if the vehicle is not traveling in the first section (step S11: No), the control device 100 determines that the vehicle is traveling in the second section different from the first section, and performs autonomous traveling based on the external environment recognition data by the AD_ECU 132 (step S13). Even when it is determined that the vehicle is traveling on the private land, if the travel area is not the first section, that is, if the travel area is a section in which the vehicle can move based on the external environment recognition data without referring to the route history, the process proceeds to step S13.

On the other hand, in step S11, if the vehicle is traveling in the first section (step S11: Yes), the control device 100 performs autonomous traveling based on the route history by the ADAS_ECU 131 (step S12).

The processing from step S12 to step S14 is the same as the processing from step S12 to step S14 illustrated in FIG. 4.

As described above, according to the control device 100 of this modification, it is determined whether the vehicle 1 is traveling on a private land. When the vehicle 1 is not traveling on a private road, it is determined that the vehicle 1 is traveling on a general road, and movement control of the vehicle 1 based on external environment recognition data by the AD_ECU 132 in a second section different from the first section is performed. Therefore, when the vehicle 1 is traveling in an area other than a private land, the determination as to whether the vehicle 1 is traveling in the first section (repeated consecutive determination) is unnecessary, and it is sufficient to perform the determination as to whether the vehicle is traveling in the first section only when the vehicle is traveling on a private land. Therefore, the determination can be performed efficiently.

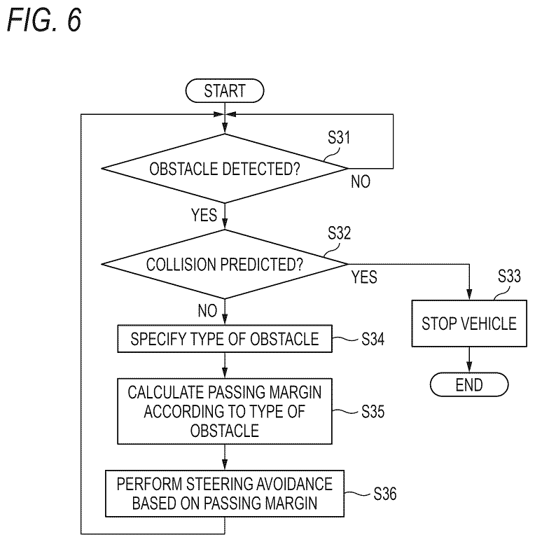

FIG. 6 is a flowchart illustrating an example of control during autonomous traveling based on a route history by the ADAS_ECU 131. For example, the process is an example of control in step S12 in the movement control in FIG. 4 or FIG. 5.

Even during the execution of the movement control by the ADAS_ECU 131 based on the route history in the first section, the control device 100 performs the route generation based on the external environment recognition data by the AD_ECU 132 in parallel.

The control device 100 determines whether an obstacle is detected based on the external environment recognition data by the AD_ECU 132 (step S31). As described above, the obstacle is an object that obstructs the movement of the vehicle 1 according to the movement control.

In step S31, if no obstacle is detected (step S31: No), the control device 100 repeats the detection determination in step S31.

In step S31, if an obstacle is detected (step S31: Yes), the control device 100 determines whether it is predicted that the vehicle 1 collides with the detected obstacle when the execution of the current movement control by the ADAS_ECU 131 based on the route history is continued (step S32).

In step S32, if it is predicted that the vehicle collides with the obstacle (step S32: Yes), the control device 100 stops the vehicle 1 (step S33).

In step S32, if it is not predicted that the obstacle collides with the obstacle (step S32: No), the control device 100 performs processing of specifying a type of the obstacle (step S34). The type of the obstacle is, for example, a stationary object such as a permanently installed dustbin or an object that can move such as a moving vehicle or a person.

Next, the control device 100 calculates a passing margin according to the type of the obstacle specified in step S34 (step S35). When the obstacle is an object that can move, a larger passing margin is calculated than when the obstacle is a stationary object.

Next, the control device 100 performs steering avoidance with respect to the obstacle based on the passing margin calculated in step S35 (step S36).

As described above, according to the control device 100 of this example, in the movement control based on the route history by the ADAS_ECU 131, when an obstacle is detected based on the external environment recognition data in the middle of the movement control, it is possible to perform steering avoidance with respect to the obstacle by securing a passing margin according to the type of the obstacle. Therefore, it is possible to generate a more appropriate travel route according to the road condition under which the vehicle 1 travels.

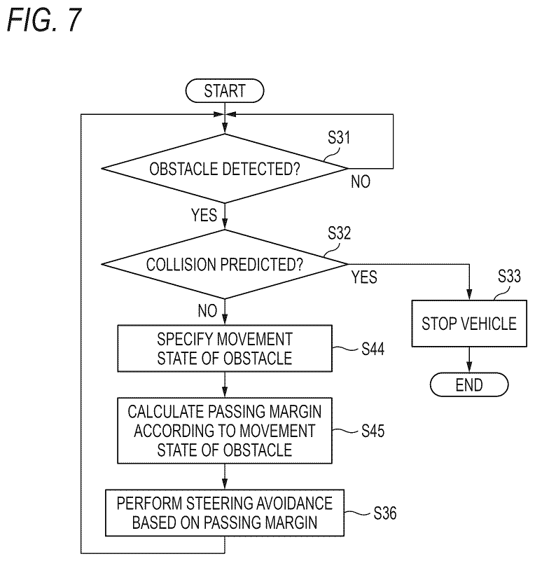

FIG. 7 is a flowchart illustrating a modification of control during autonomous traveling based on a route history by the ADAS_ECU 131.

As illustrated in FIG. 7, the processing from step S31 to step S33 is the same as that from step S31 to step S33 described with reference to FIG. 6.

In step S32, if it is not predicted that the vehicle collides with the obstacle (step S32: No), the control device 100 performs processing of specifying a movement state of the obstacle (step S44). The movement state of the obstacle is whether the object determined as an obstacle is moving.

Next, the control device 100 calculates a passing margin according to the movement state of the obstacle specified in step S44 (step S45). The “according to the movement state” means according to a moving direction, a moving speed, and the like. When the obstacle is approaching the host vehicle 1, a larger passing margin is calculated than when the obstacle is not approaching the vehicle. When the obstacle moves fast, a larger passing margin is calculated than when the obstacle moves slowly. Also in this example, the type of the obstacle may be determined, and the passing margin may be calculated also in consideration of a determination result for the type.

The processing of step S36 is the same as the processing of step S36 described with reference to FIG. 6.

As described above, according to the control device 100 of this example, in the movement control based on the route history by the ADAS_ECU 131, when an obstacle is detected based on the external environment recognition data in the middle of the movement control, it is possible to perform steering avoidance with respect to the obstacle by securing a passing margin according to the movement state of the obstacle. Therefore, it is possible to generate a more appropriate travel route according to the road condition under which the vehicle 1 travels.

The control method described in the above embodiment may be implemented by a computer executing a control program prepared in advance. The control program is stored in a computer-readable storage medium and executed by being read from the storage medium. Further, the control program may be provided in a form stored in a non-transitory storage medium such as a flash memory, or may be provided via a network such as the Internet. The computer that executes the control program may be provided in the control device, may be provided in an electronic device such as a smartphone, a tablet terminal, or a personal computer that can communicate with the control device, or may be provided in a server device that can communicate with the control device and the electronic device.

Although the embodiment of the present disclosure has been described above, the present disclosure is not limited to the above-described embodiment, and modifications, improvements, and the like can be appropriately made.

For example, although an example in which the moving object is a vehicle has been described in the above embodiment, the present disclosure is not limited thereto. The idea of the present disclosure is not limited to the vehicle, and may also be applied to a robot, a ship, an aircraft, or the like that includes a drive source and that can be moved by power of the drive source.

In the present specification, at least the following matters are described. Although corresponding constituent elements or the like in the embodiment described above are shown in parentheses, the present disclosure is not limited thereto.
(1) A control device for a moving object (vehicle 10), the control device including:
an external environment recognition unit (external environment recognition unit 110) configured to acquire external environment recognition data of the moving object;
a storage unit (storage unit 120) configured to store a route history of the route used when the moving object moves to a target position; and
a movement control unit (movement control unit 130) configured to perform movement control of moving the moving object to the target position along a section to the target position, in which
the movement control unit switches a usage mode of the route history in the movement control in a first section included in the section in which it is difficult to move without referring to the route history and a second section that is included in the section and that is different from the first section, and generates a travel route.

According to (1), it is possible to switch the usage mode of the route history in generating the travel route in the movement control of the moving object in the first section and the second section of the section to the target position, and thus it is possible to generate an appropriate travel route according to a road condition where the moving object moves.
(2) The control device according to (1), in which
the movement control unit performs the movement control by referring to the route history in the first section, and performs the movement control based on the external environment recognition data without referring to the route history in the second section.

According to (2), the moving object is moved under control by referring to the route history in the first section of the section to the target position in which it is difficult to move without referring to the route history, and the moving object is moved under control based on the external environment recognition data in the second section different from the first section, and thus it is possible to generate a more appropriate travel route according to the road condition.
(3) The control device according to (2), in which
the movement control unit includes
   a first control unit (ADAS_ECU 131) configured to control garage entry and exit of the moving object, and
   a second control unit (AD_ECU 132) configured to control traveling of the moving object different from the garage entry and exit,
the first control unit performs the movement control in the first section, and
the second control unit performs the movement control in the second section.

According to (3), in the first section, the movement control of the moving object is performed by the first control unit that controls the garage entry and exit of the moving object, and thus it is possible to generate an appropriate travel route for the garage entry and exit where it is difficult to move without referring to the route history, for example. In addition, in the second section, the movement control of the moving object is performed by the second control unit that controls the travelling of the moving object that is different from the garage entry and exit, and thus it is possible to generate a travel route based on the external environment recognition data in travelling on a general road, for example.
(4) The control device according to (3), in which
when an obstacle is detected based on the external environment recognition data even during execution of the movement control in the first section, the movement control unit switches the movement control performed by the first control unit to the movement control performed by the second control unit.

According to (4), when an obstacle is detected based on the external environment recognition data even during the execution of the movement control performed by the first control unit with reference to the route history in the first section, the movement control is switched to the movement control performed by the second control unit, which is based on the external environment recognition data and can flexibly cope with an environmental change, and thus it is possible to generate an appropriate travel route according to the road condition.
(5) The control device according to any one of (1) to (4), in which
the movement control unit sets the first section and the second section based on the external environment recognition data.

According to (5), by setting the first section and the second section of the section to the target position based on the external environment recognition data, it is possible to generate a more appropriate travel route according to the road condition.
(6) The control device according to any one of (1) to (5), in which
the movement control unit sets the first section and the second section based on a travel history generated when a user drives the moving object.

According to (6), by setting the first section and the second section of the section to the target position based on the travel history generated when the user drives the moving object, it is possible to generate a more appropriate travel route according to the road situation.
(7) The control device according to any one of (1) to (6), in which
when an obstacle is detected during execution of the movement control in the first section, the movement control unit performs the movement control based on at least one of a type of the obstacle and a movement state of the obstacle.

According to (7), by performing the movement control of the moving object in the first section based on the type and the movement state of the detected obstacle, it is possible to generate a more appropriate travel route according to the road situation.
(8) A control method for a moving object, the moving object including an external environment recognition unit configured to acquire external environment recognition data of the moving object, a storage unit configured to store a route history of a route used when the moving object moves to a target position, and a movement control unit configured to perform movement control of moving the moving object to the target position along a section to the target position, the control method comprising:
switching, by the movement control unit, a usage mode of the route history in the movement control in a first section included in the section in which it is difficult to move without referring to the route history and a second section that is included in the section and that is different from the first section, and generates a travel route.

According to (8), it is possible to switch the usage mode of the route history in generating the travel route in the movement control of the moving object in the first section and the second section of the section to the target position, and thus it is possible to generate an appropriate travel route according to a road condition where the moving object moves.
(9) A non-transitory computer-readable storage medium storing a control program for a moving object, the moving object including an external environment recognition unit configured to acquire external environment recognition data of the moving object, a storage unit configured to store a route history of a route used when the moving object moves to a target position, and a movement control unit configured to perform movement control of moving the moving object to the target position along a section to the target position, the control program causing the movement control unit to execute a process, the process including:
switching a usage mode of the route history in the movement control in a first section included in the section in which it is difficult to move without referring to the route history and a second section that is included in the section and that is different from the first section, and generates a travel route.

According to (9), it is possible to switch the usage mode of the route history in generating the travel route in the movement control of the moving object in the first section and the second section of the section to the target position, and thus it is possible to generate an appropriate travel route according to a road condition where the moving object moves.

What is claimed is:

1. A control device for a moving object, the control device comprising:
an external environment recognition unit configured to acquire external environment recognition data of the moving object;
a storage unit configured to store a route history of the route used when the moving object moves to a target position; and
a movement control unit configured to perform movement control of moving the moving object to the target position along a section to the target position, wherein
the movement control unit switches a usage mode of the route history in the movement control in a first section included in the section in which it is difficult to move without referring to the route history and a second section that is included in the section and that is different from the first section, and generates a travel route.

2. The control device according to claim 1, wherein
the movement control unit performs the movement control by referring to the route history in the first section, and performs the movement control based on the external environment recognition data without referring to the route history in the second section.

3. The control device according to claim 2, wherein
the movement control unit includes
a first control unit configured to control garage entry and exit of the moving object, and
a second control unit configured to control traveling of the moving object different from the garage entry and exit,
the first control unit performs the movement control in the first section, and
the second control unit performs the movement control in the second section.

4. The control device according to claim 3, wherein
when an obstacle is detected based on the external environment recognition data even during execution of the movement control in the first section, the movement control unit switches the movement control performed by the first control unit to the movement control performed by the second control unit.

5. The control device according to claim 1, wherein
the movement control unit sets the first section and the second section based on the external environment recognition data.

6. The control device according to claim 1, wherein
the movement control unit sets the first section and the second section based on a travel history generated when a user drives the moving object.

7. The control device according to claim 1, wherein
when an obstacle is detected during execution of the movement control in the first section, the movement control unit performs the movement control based on at least one of a type of the obstacle and a movement state of the obstacle.

8. A control method for a moving object, the moving object including an external environment recognition unit configured to acquire external environment recognition data of the moving object, a storage unit configured to store a route history of a route used when the moving object moves to a target position, and a movement control unit configured to perform movement control of moving the moving object to the target position along a section to the target position, the control method comprising:
switching, by the movement control unit, a usage mode of the route history in the movement control in a first section included in the section in which it is difficult to move without referring to the route history and a second section that is included in the section and that is different from the first section, and generates a travel route.

9. A non-transitory computer-readable storage medium storing a control program for a moving object, the moving object including an external environment recognition unit configured to acquire external environment recognition data of the moving object, a storage unit configured to store a route history of a route used when the moving object moves to a target position, and a movement control unit configured to perform movement control of moving the moving object to the target position along a section to the target position, the control program causing the movement control unit to execute a process, the process comprising:
switching a usage mode of the route history in the movement control in a first section included in the section in which it is difficult to move without referring to the route history and a second section that is included in the section and that is different from the first section, and generates a travel route.
